(19) United States
(12) Patent Application Publication
(10) Pub. No.: US 2016/0153748 A1
(43) Pub. Date: Jun. 2, 2016

(54) Gel comfort gun holster

(71) Applicant: Christopher Adam Tedder, Van Buren, AR (US)

(72) Inventor: Christopher Adam Tedder, Van Buren, AR (US)

(21) Appl. No.: 14/544,151

(22) Filed: Dec. 2, 2014

(51) Int. Cl. F41C 33/04; B32B 9/02

(52) U.S. Cl. CPC F41C 33/04; B32B 9/025; B32B 2307/56

(57) ABSTRACT

A Gel Comfort Gun Holster puts a gel pad on a gun holster to make carrying the gun next to the user's body more comfortable than a typical holster. Typical holsters encase the handgun in a material to secure the handgun and cover the trigger. The typical material used to make a handgun holster is leather, plastic, and nylon. These materials are not very comfortable when pressed against the user's body. Gel Comfort Gun Holsters solve this problem by attaching a gel pad to the holster body. The gel pad distributes the pressure of the holster and handgun pressed against the user's body, making the Gel Comfort Gun Holster much more comfortable to carry than a traditional handgun holster.

### BACKGROUND OF INVENTION

Gun Holsters are uncomfortable because the plastic or leather or other materials of a typical gun holster are not comfortable for the user when the gun is carried against the users body. This is especially true if the gun is able to press through the material as it does with leather. Leather holsters, leather-backed holsters, nylon holsters, plastic holsters, and other holsters produced from hard materials or materials that allow the gun to press through it are uncomfortable for the user because the gun or holster body produces a pressure point on the user's body. This problem is solved by the Gel Comfort Gun Holster because the pressure point is alleviated by the gel cushion.

### BRIEF SUMMARY OF INVENTION

When a gun or gun holster is carried by a user, the hard surface of the gun or gun holster body causes a pressure point against the user's body

Gel Comfort Gun Holsters provide comfort to the user by evenly distributing the pressure of the gun or gun holster body that presses against the user. Leather holsters, leather-backed holsters, nylon holsters, plastic holsters, and other holsters produced from hard materials or materials that allow the gun to press through it are uncomfortable for the user because the gun or holster body produces a pressure point on the user's body. This problem is solved by the Gel Comfort Gun Holster because the pressure point is alleviated by the gel cushion.

### DETAILED DESCRIPTION OF INVENTION

This nonprovisional patent application refers to provisional patent application No. 61/963358.

### Explanation of Invention

The Gel Comfort Gun Holster uses a gel pad to evenly distribute the pressure that a pistol or holster body exerts on the user's body. This allows the user to carry their handgun next to their body comfortably with a much wider pressure point. The Gel Comfort Gun Holster consists of a holster body and a gel pad. The holster body wraps around the pistol and allows it to be carried safely on the user's body by attaching to the body or belt. The holster body can consist of plastic, leather, nylon or other material that is sufficient to carry the weapon. The gel pad attaches to the holster on the side that presses against the users body. The gel pad can be covered in suede or other material.

### Distinguish from Other Inventions

The Gel Comfort Gun Holster differs from other holsters because no other holster uses gel to protect the user from the pressure points caused by carrying a pistol next to the user's body. Most other holsters use plastic, leather, or nylon against the user which does not distribute pressure caused by carrying a pistol next to the body very well. Some holsters use neoprene as a cushion. Leather, plastic, nylon, and neoprene used by other holsters cannot distribute pressure as efficiently or as comfortably as gel.

### Process of Making Invention

The holster body is made by forming plastic, nylon, leather, or other material around the handgun. The holster body should securely hold the handgun and cover the trigger to prevent accidental discharge. If the holster is to be carried on a belt, belt clips are attached to the holster body so that the holster can be attached to a belt. If the holster is to worn around an ankle, under a shoulder or other place on the user's body, then straps are attached to the holster body so that the holster can be attached to the user's body. If the holster is to be carried in a user's pocket, a clip or strap does not need to be added to the holster. Suede is wrapped around and attached to the gel padding using adhesive or by sewing the gel and suede together. The gel padding is then attached to the holster body with adhesives or by sewing the gel pad to the holster body.

### Using the Invention

The Gel Comfort Gun Holster is carried next to the user's body. It can be carried inside the waistband, clipped to a belt or pants. It can be carried outside the waistband, clipped to a belt or pants. It can be carried in a pocket. It can be carried strapped to an ankle. It can also be carried under a user's shoulder with straps. The user wears the Gel Comfort Gun Holster so that the gel pad is against the user's skin.

### DESCRIPTION OF DRAWINGS

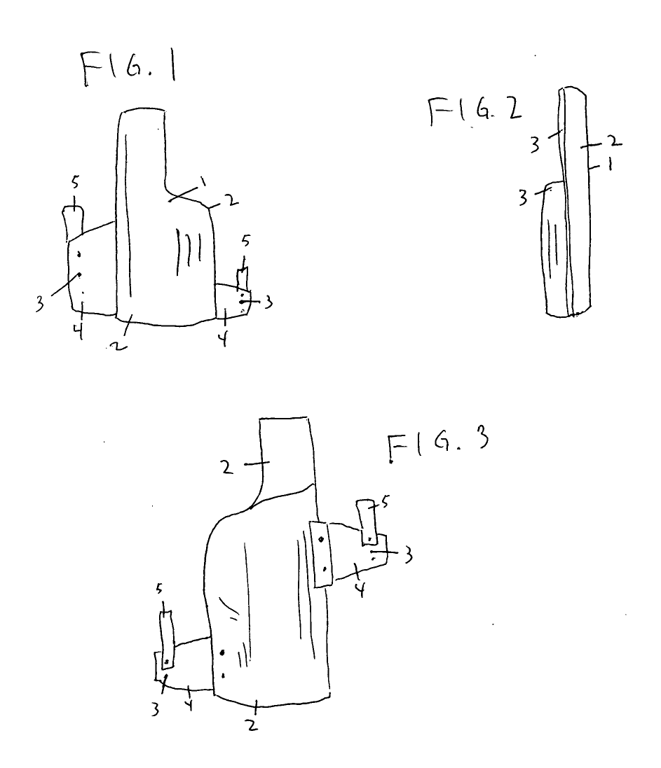

FIG. 1—back view
1) Suede-Covered Gel backing
2) Holster body
3) Holes for belt clip
4) Leather tabs to hold belt clips
5) Belt Clips

FIG. 2—side view
1) Suede
2) Gel
3) Holster body

FIG. 3—front view
2) Holster body
3) Holes for belt clip
4) Leather tabs to hold belt clips
5) Belt Clips

What is claimed is:

1. A handgun holster with a gel pad attached to the side of said gun holster.
